(19) United States
(12) Patent Application Publication
(10) Pub. No.: US 2022/0000015 A1
(43) Pub. Date: Jan. 6, 2022

(54) CLOSING SYSTEM FOR A SEEDER ROW UNIT

(71) Applicant: CNH Industrial Canada, Ltd., Saskatoon (CA)

(72) Inventors: Trevor Lawrence Kowalchuk, Saskatoon (CA); Dennis George Thompson, Saskatoon (CA)

(73) Assignee: CNH Industrial Canada, Ltd.

(21) Appl. No.: 17/360,688

(22) Filed: Jun. 28, 2021

Related U.S. Application Data
(60) Provisional application No. 63/046,865, filed on Jul. 1, 2020.

(51) Int. Cl. A01C 7/20; A01C 5/06

(52) U.S. Cl. CPC A01C 7/203; A01C 7/208; A01C 5/068

(57) ABSTRACT

A row unit of a seeder includes a frame configured to be coupled to a toolbar of the seeder. The row unit also includes a single opener disc rotatably coupled to the frame and a closing system. The closing system includes a closing disc arm pivotally coupled to the frame and a closing disc rotatably coupled to the closing disc arm. The closing system also includes a packer wheel arm pivotally coupled to the frame. The packer wheel arm and the closing disc arm are configured to rotate independently of one another relative to the frame. In addition, the closing system includes a packer wheel rotatably coupled to the packer wheel arm. Furthermore, an agricultural product storage compartment is not non-movably coupled to the frame.

### BACKGROUND

The present disclosure relates generally to a closing system for a seeder row unit.

Generally, agricultural seeding implements (e.g., seeders) are towed behind a tractor or other work vehicle via a mounting bracket secured to a rigid frame of the implement. Seeding implements typically include multiple row units distributed across a width of the implement. Each row unit is configured to deposit seeds at a target depth beneath the soil surface of a field, thereby establishing rows of planted seeds. For example, each row unit typically includes a ground engaging tool or opener that forms a seeding path (e.g., trench) for seed deposition into the soil. A seed tube (e.g., positioned adjacent to the opener) is configured to deposit seeds into the trench. The opener/seed tube may be followed by a packer wheel that packs the soil on top of the deposited seeds. Unfortunately, while the row unit is operating within fields having certain soil types and/or certain soil conditions, the packer wheel may not effectively close the trench and/or break up the side walls of the trench. Accordingly, the resultant yield performance from the deposited seeds may be reduced.

### BRIEF DESCRIPTION

In certain embodiments, a row unit of a seeder includes a frame configured to be coupled to a toolbar of the seeder. The row unit also includes a single opener disc rotatably coupled to the frame and a closing system. The closing system includes a closing disc arm pivotally coupled to the frame and at least one closing disc rotatably coupled to the closing disc arm. The closing disc arm positions a rotational axis of the at least one closing disc rearward of a rotational axis of the single opener disc relative to a direction of travel of the row unit. The closing system also includes a packer wheel arm pivotally coupled to the frame. The packer wheel arm and the closing disc arm are configured to rotate independently of one another relative to the frame. In addition, the closing system includes a packer wheel rotatably coupled to the packer wheel arm. The packer wheel arm positions a rotational axis of the packer wheel rearward of the rotational axis of the at least one closing disc relative to the direction of travel of the row unit. Furthermore, an agricultural product storage compartment (e.g., an on-row hopper, a mini hopper, etc.) is not non-movably coupled (e.g., fixedly coupled, etc.) to the frame.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural seeding implement having multiple row units;

FIG. 2 is a side view of an embodiment of a row unit that may be employed within the agricultural seeding implement of FIG. 1, in which the row unit has an embodiment of a closing system; and

FIG. 3 is a side view of the row unit of FIG. 2 having another embodiment of a closing system.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

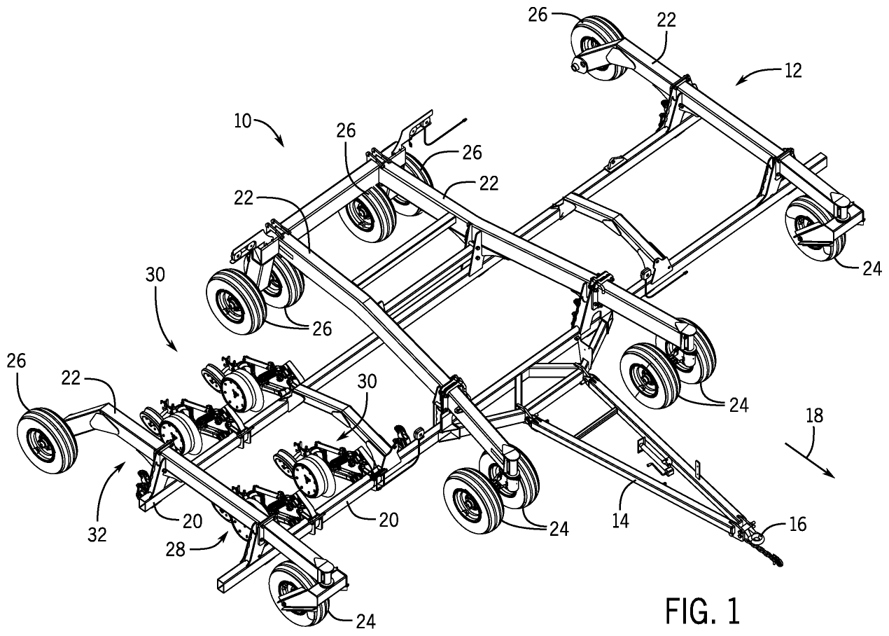

FIG. 1 is a perspective view of an embodiment of an agricultural seeding implement 10 (e.g., seeder) having multiple row units. As illustrated, the agricultural seeding implement 10 includes a frame 12 and a tow bar 14 coupled to the frame 12. In the illustrated embodiment, the tow bar 14 is pivotally coupled to the frame 12 and includes a hitch 16. The hitch 16 is configured to interface with a corresponding hitch of a work vehicle (e.g., tractor, etc.), thereby enabling the work vehicle to tow the agricultural seeding implement 10 through a field along a direction of travel 18. While the illustrated tow bar 14 forms an A-frame, in certain embodiments, the tow bar may have any other suitable configuration (e.g., a single bar extending along the direction of travel, etc.). In addition, while the tow bar 14 is pivotally coupled to the frame 12 in the illustrated embodiment, in certain embodiments, the tow bar may be rigidly coupled to the frame. Furthermore, in certain embodiments, the hitch 16 may be coupled to a corresponding hitch of another implement (e.g., an air cart, etc.), and the other implement may be coupled to the work vehicle (e.g., via respective hitches). While the agricultural seeding implement 10 is configured to be towed through the field by a work vehicle in the illustrated embodiment, in certain embodiments, the agricultural seeding implement may be part of a self-propelled vehicle (e.g., in which the frame of the agricultural seeding implement is coupled to a main frame/chassis of the self-propelled vehicle).

In the illustrated embodiment, the frame 12 of the agricultural seeding implement 10 includes two toolbars 20 and four supports 22. As illustrated, wheels are coupled to the supports 22, and the supports 22 are coupled to the toolbars 20 (e.g., via fasteners, via a welded connection, etc.). In the illustrated embodiment, front wheel(s) 24 are rotatably coupled to a respective front portion of each support 22, and rear wheel(s) 26 are rotatably coupled to a respective rear portion of each support 22. The front portion of each support 22 is positioned forward of the respective rear portion relative to the direction of travel 18. The wheels maintain the supports 22 above the surface of the field and enable the agricultural seeding implement 10 to move along the direction of travel 18. In the illustrated embodiment, pivotal connections between the front wheels 24 and the respective supports 22 enable the front wheels 24 to caster, thereby enhancing the turning ability of the agricultural seeding implement 10 (e.g., at a headland, during transport, etc.). However, in certain embodiments, at least one front wheel may be non-pivotally coupled to the respective support, and/or at least one rear wheel may be pivotally coupled to the respective support. While the frame 12 of the agricultural seeding implement 10 has four supports 22 in the illustrated embodiment, in certain embodiments, the agricultural seeding implement may have more or fewer supports (e.g., 0, 1, 2, 3, 4, 5, 6, or more). Furthermore, in certain embodiments, the toolbars 20 of the frame 12 may be supported by other and/or additional suitable structures (e.g., connectors extending between toolbars, wheel mounts coupled to toolbars, etc.).

In the illustrated embodiment, a first row 28 of row units 30 is coupled to the front toolbar 20, and a second row 32 of row units 30 is coupled to the rear toolbar 20. While the agricultural seeding implement 10 has two toolbars 20 and two corresponding rows of row units 30 in the illustrated embodiment, in other embodiments, the agricultural seeding implement may include more or fewer toolbars (e.g., 1, 2, 3, 4, 5, 6, or more) and a corresponding number of rows of row units. Furthermore, while the agricultural seeding implement 10 includes one type of row unit in the illustrated embodiment, in other embodiments, the agricultural seeding implement may include multiple types of row units and/or other suitable agricultural tools (e.g., spray nozzle(s), finishing reel(s), tillage shank(s), etc.). In addition, while the row units are directly coupled to the toolbars in the illustrated embodiment, in other embodiments, at least a portion of the row units may be coupled to one or more sub-frames/sub-bars, which are movably (e.g., rotatably and/or translatably) coupled to the toolbar(s). For example, one or more groups of row units (e.g., gang(s) of row units) may be coupled to one or more respective sub-frames/sub-bars that are movably coupled to respective toolbar(s).

In the illustrated embodiment, each row unit 30 of the agricultural seeding implement 10 is configured to deposit agricultural product (e.g., seed, fertilizer, etc.) into the soil. For example, certain row units 30 (e.g., all of the row units 30 of the agricultural seeding implement 10, a portion of the row units 30 of the agricultural seeding implement 10, at least one row unit 30 of the agricultural seeding implement 10, etc.) include an opener disc configured to form a trench within the soil for agricultural product deposition into the soil. The row unit 30 also includes a gauge wheel (e.g., positioned adjacent to the opener disc) configured to control a penetration depth of the opener disc into the soil. For example, the opener disc may be rotatably coupled, and in certain embodiments non-movably coupled, to a frame of the row unit, and the gauge wheel may be movably coupled to the frame and configured to contact a surface of the soil during operation of the row unit. Accordingly, adjusting the vertical position of the gauge wheel relative to the frame of the row unit controls the penetration depth of the opener disc into the soil. In addition, the row unit includes a product tube (e.g., seed tube) configured to deposit the agricultural product into the trench formed by the opener disc.

The opener disc/agricultural product tube is followed by a closing system. The closing system includes a closing assembly having at least one closing disc configured to close the trench formed by the opener disc and/or to break up the side wall(s) of the trench. The closing system also includes a packer assembly that follows the closing assembly. The packer assembly includes a packer wheel configured to pack soil on top of the deposited agricultural product. In certain embodiments, each row unit 30 of the second row 32 is laterally offset (e.g., offset in a direction perpendicular to the direction of travel 18) from a respective row unit 30 of the first row 28, such that two adjacent rows of agricultural product are established within the soil. While the illustrated agricultural seeding implement 10 includes two row units 30 in the first row 28 and two row units 30 in the second row 32 for illustrative purposes, the agricultural seeding implement may have any suitable number of row units in the first row and any suitable number of row units in the second row. For example, the agricultural seeding implement may include 5, 10, 15, 20, 25, or 30 row units in the first row and a corresponding number of row units in the second row. Furthermore, in certain embodiments, the second row may include more or fewer row units than the first row.

In certain embodiments, the agricultural seeding implement and/or at least one row unit of the agricultural seeding implement includes a downforce actuator configured to control a downforce applied by the row unit gauge wheel to the soil surface. For example, in certain embodiments, the agricultural seeding implement may include multiple downforce actuators each configured to control the downforce applied by the gauge wheels of a group of row units (e.g., on a sub-frame/sub-bar) coupled to the downforce actuator. The downforce actuator may enable the downforce applied by the respective gauge wheel(s) to the soil surface to be adjusted based on soil condition(s), soil type, agricultural product type (e.g., seed type, fertilizer type, etc.), other suitable parameter(s), or a combination thereof. For example, the downforce may be reduced for moist soil conditions to reduce compaction, and the downforce may be increased for harder soil to enable the gauge wheel(s) to maintain contact with the soil surface.

As previously discussed, each row unit 30 includes a closing system having a closing assembly and a packer assembly. The closing assembly includes a closing disc arm pivotally coupled to the frame of the row unit. The closing assembly also includes at least one closing disc rotatably coupled to the closing disc arm. The closing disc arm positions a rotational axis of the at least one closing disc rearward of a rotational axis of the opener disc relative to the direction of travel 18. In addition, the packer assembly includes a packer wheel arm pivotally coupled to the frame. As discussed in detail below, the packer wheel arm and the closing disc arm are configured to rotate independently of one another relative to the frame. The packer assembly also includes a packer wheel rotatably coupled to the packer wheel arm. The packer wheel arm positions a rotational axis of the packer wheel rearward of the rotational axis of the at least one closing disc relative to the direction of travel. Because the packer wheel arm and the closing disc arm are configured to rotate independently of one another relative to the frame, the contact force between the packer wheel and the soil may be controlled substantially independently of the contact force between the closing disc(s) and the soil. For example, each contact force may be adjusted for particular field conditions (e.g., soil composition, soil moisture, etc.). As a result, the closing system disclosed herein may be utilized to effectively close the trench and/or break up the side wall(s) of the trench for a variety of field conditions.

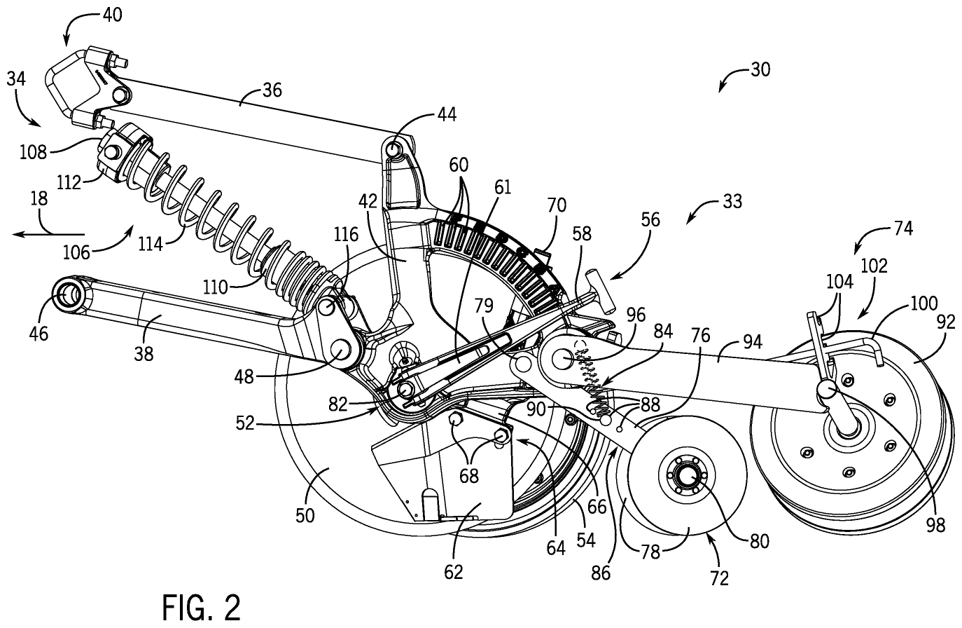

FIG. 2 is a side view of an embodiment of a row unit 30 (e.g., agricultural row unit, seeder row unit) that may be employed within the agricultural seeding implement of FIG. 1, in which the row unit has an embodiment of a closing system 33. In the illustrated embodiment, the row unit 30 includes a linkage assembly 34 configured to couple (e.g., movably couple) the row unit 30 to a respective toolbar of the agricultural seeding implement. The linkage assembly 34 includes an upper link 36 and a lower link 38. A mount 40 is positioned at a first end of the upper link 36 and is configured to couple to the respective toolbar of the agricultural seeding implement. In addition, a second end of the upper link 36 is coupled to a frame 42 of the row unit 30 by a fastener 44. The lower link 38 includes an opening 46 configured to receive a fastener that rotatably couples the lower link 38 to the respective toolbar (e.g., via a rockshaft that is rotatably coupled to the respective toolbar). In addition, a second end of the lower link 38 is coupled to the frame 42 of the row unit by a fastener 48. The linkage assembly 34 enables the frame 42 of the row unit 30 to move vertically (e.g., raise and lower) relative to the respective toolbar (e.g., in response to the opener disc/gauge wheel contacting an obstruction, in response to variations in the terrain, for raising the row unit frame for transport, etc.). While the row unit 30 includes the linkage assembly 34 having the upper link 36 and the lower link 38 in the illustrated embodiment, in other embodiments, the row unit may include any other suitable linkage configuration to facilitate vertical movement of the row unit frame relative to the respective toolbar. Furthermore, in certain embodiments, the row unit frame may be non-movably coupled to the respective toolbar.

In the illustrated embodiment, the row unit 30 includes an opener disc 50 rotatably and non-movably coupled to the frame 42 by a bearing assembly 52. For example, the bearing assembly may be disposed within a hub assembly that is coupled to the frame by a spindle. The bearing assembly 52 enables the opener disc 50 to freely rotate as the opener disc engages the soil, thereby enabling the opener disc 50 to excavate a trench within the soil. In the illustrated embodiment, the row unit 30 includes a single opener disc 50. Accordingly, the opener disc 50 is the only element on the row unit configured to initiate formation of a trench within the soil. While the opener disc is rotatably coupled to the frame by the bearing assembly in the illustrated embodiment, in other embodiments, the opener disc may be rotatably coupled to the frame by another suitable device (e.g., fastener, etc.).

In the illustrated embodiment, the row unit 30 includes a gauge wheel 54 configured to control a penetration depth of the opener disc 50 into the soil. The gauge wheel 54 is configured to rotate along the surface of the soil. Accordingly, adjusting the vertical position of the gauge wheel 54 relative to the frame 42 controls the penetration depth of the opener disc 50 into the soil. The gauge wheel 54 is rotatably coupled to a gauge wheel support arm, and the gauge wheel support arm is pivotally coupled to the frame 42. Accordingly, pivoting of the gauge wheel support arm drives the gauge wheel 54 to move vertically relative to the frame 42. In certain embodiments, the gauge wheel 54 is positioned against the opener disc 50 to remove soil from a side of the opener disc 50 during operation of the row unit 30.

The row unit 30 includes a depth adjustment assembly 56 configured to control the vertical position of the gauge wheel 54, thereby controlling the penetration depth of the opener disc 50 into the soil. In the illustrated embodiment, the depth adjustment assembly 56 includes a depth adjustment handle 58 and depth gauge notches 60. The depth adjustment handle 58 is non-rotatably coupled to the gauge wheel support arm and configured to drive the gauge wheel support arm to pivot, thereby controlling the vertical position of the gauge wheel 54 relative to the frame 42/opener disc 50. The depth adjustment handle 58 may be moved to any of the depth gauge notches 60 to adjust the vertical position of the gauge wheel 54. The depth gauge notches 60 block rotation of the depth adjustment handle 58, thereby maintaining the vertical position of the gauge wheel 54 (e.g., substantially fixing the position of the gauge wheel 54 relative to the frame 42). To adjust the vertical position of the gauge wheel 54/penetration depth of the opener disc 50, the depth adjustment handle 58 may be moved away from the depth gauge notches 60, thereby facilitating rotation of the depth adjustment handle 58 along the depth gauge notches 60. Upon release of the depth adjustment handle 58, a biasing member 61 may urge the depth adjustment handle 58 to engage the depth gauge notches 60, thereby blocking rotation of the depth gauge handle 58 among the depth gauge notches 60. While the vertical position of the gauge wheel/penetration depth of the opener disc is controlled by the depth adjustment handle/depth gauge notches in the illustrated embodiment, in other embodiments, another suitable depth adjustment assembly/device, such as an actuator, may be used to control the vertical position of the gauge wheel/penetration depth of the opener disc.

In the illustrated embodiment, the row unit 30 includes a scraper 62 disposed adjacent to the opener disc 50 and configured to remove accumulated soil from the opener disc 50. As illustrated, a mounting portion 64 of the scraper 62 is rigidly coupled to a mounting bracket 66 by fasteners 68. In alternative embodiments, the scraper may be coupled directly to the frame, or the scraper may be mounted to another suitable mounting structure. In the illustrated embodiment, the mounting bracket 66 is pivotally coupled to the frame 42 by a shaft, and a biasing member urges the bracket 66/scraper 62 toward the opener disc 50, thereby facilitating debris removal. While the illustrated row unit includes a scraper, in other embodiments, the scraper may be omitted. Furthermore, the row unit 30 includes an agricultural product tube 70 (e.g., seed tube) configured to direct agricultural product into the trench formed by the opener disc 50.

In the illustrated embodiment, the row unit 30 includes a closing system 33 configured to close the trench formed by the opener disc 50 and to pack soil on top of the deposited agricultural product. The closing system 33 includes a closing assembly 72 and a packer assembly 74. The closing assembly 72 includes a closing disc arm 76 and two closing discs 78 rotatably coupled to the closing disc arm 76. As illustrated, the closing disc arm 76 is pivotally coupled to the frame 42 at a pivot joint 79 (e.g., first pivot joint), and the closing disc arm 76 positions a rotational axis 80 of each closing disc 78 rearward of a rotational axis 82 of the opener disc 50 relative to the direction of travel 18 of the row unit 30. The closing discs 78 are configured to close the trench formed by the opener disc and/or to break up the side wall(s) of the trench, thereby enhancing the development of crops from the deposited seeds. In the illustrated embodiment, the closing discs 78 are substantially smooth. However, in other embodiments, at least one of the closing discs may be wavy and/or have multiple spikes extending radially outward from a central hub of the closing disc. Furthermore, in the illustrated embodiment, the closing assembly 72 has two closing discs 78. However, in other embodiments, the closing assembly may have more or fewer closing discs (e.g., 1, 2, 3, 4, or more). For example, a first pair of closing discs may be coupled to the frame of the row unit by a first arm, and a second pair of closing discs (e.g., positioned rearward of the first pair of closing discs) may be coupled to the frame of the row unit by a second arm.

In the illustrated embodiment, the closing assembly 72 of the closing system 33 includes a closing disc biasing element 84 coupled to the closing disc arm 76 and configured to urge the closing discs 78 (e.g., the rotational axes of the closing discs) toward the soil (e.g., soil surface). In the illustrated embodiment, the biasing element 84 includes a single coil spring. However, in other embodiments, the biasing element may include an alternative biasing device and/or additional biasing device(s) (e.g., leaf spring(s), pneumatic cylinder(s), hydraulic cylinder(s), resilient member(s), etc.) configured to urge the closing discs toward the soil. Furthermore, in the illustrated embodiment, the closing assembly 72 includes a closing disc adjustment assembly 86 configured to control contact force between the closing discs and the soil. In the illustrated embodiment, the closing disc adjustment assembly 86 includes a series of openings 88 disposed along the closing disc arm 76 and a pin 90 coupled to an end of the biasing element 84. The pin 90 may be engaged with a selected opening 88 to control the torque applied by the biasing element 84 to the closing disc arm 76, thereby controlling the contact force between the closing discs and the soil. While the closing disc adjustment assembly 86 includes a pin and opening in the illustrated embodiment, in other embodiments, the closing disc adjustment assembly may include other and/or additional elements to control the contact force between the closing discs and the soil. For example, if the biasing device(s) include pneumatic cylinder(s) and/or hydraulic cylinder(s), the closing disc adjustment assembly may include a valve assembly configured to control pressurized fluid flow to the pneumatic/hydraulic cylinder(s). While the closing disc biasing element 84 is coupled to the closing disc arm 76 and the frame 42 in the illustrated embodiment, in other embodiments, the closing disc biasing element may be coupled to the closing disc arm and the packer wheel arm.

As illustrated, the packer assembly 74 includes a packer wheel 92 and a packer wheel arm 94. The packer wheel arm 94 is pivotally coupled to the frame 42 at a pivot joint 96 (e.g., second pivot joint), and the packer wheel 92 is rotatably coupled to the packer wheel arm 94. The packer wheel 92 is configured to pack soil on top of the deposited agricultural product (e.g., to facilitate development of the resulting agricultural crop). The contact surface of the packer wheel may have any suitable shape (e.g., v-shaped, flat, etc.) and/or any suitable tread pattern (e.g., chevron treads, etc.). In the illustrated embodiment, the packer wheel arm 94 and the closing disc arm 76 are configured to rotate independently of one another relative to the frame. Accordingly, rotation of the packer wheel arm (e.g., in response to contact between the packer wheel and an obstruction) does not directly affect rotation of the closing disc arm, and rotation of the closing disc arm (e.g., in response to contact between the closing disc(s) and an obstruction) does not directly affect rotation of the packer wheel arm. In addition, independent rotation of the closing disc arm and the packer wheel arm enables the contact force between the closing disc(s) 78 and the soil to be adjusted independently of the contact force between the packer wheel 92 and the soil.

In addition, the packer wheel arm 94 positions a rotational axis 98 of the packer wheel 92 rearward of the rotational axis 80 of each closing disc 78 relative to the direction of travel 18 of the row unit 30. While the illustrated packer assembly includes a single packer wheel, in other embodiments, the packer assembly may include additional packer wheel(s) (e.g., distributed along the direction of travel and/or positioned side-by-side). In addition, the packer wheel (e.g., the rotational axis of the packer wheel) may be oriented at any suitable angle relative to the direction of travel and/or a vertical axis (e.g., to facilitate packing of the soil on top of the deposited agricultural product). In certain embodiments, the angle of the packer wheel (e.g., the rotational axis of the packer wheel) relative to the direction of travel and/or the vertical axis may be adjustable via a suitable adjustment mechanism. Furthermore, in the illustrated embodiment, the pivot joint 79 of the closing disc arm 76 is positioned forward of the pivot joint 96 of the packer wheel arm 94, such that the closing disc arm pivot joint is separated from the packer wheel arm pivot joint on the frame. However, in other embodiments, the closing disc arm pivot joint may be positioned rearward of the packer wheel arm pivot joint, or the packer wheel arm and the closing disc arm may utilize a common pivot joint.

In the illustrated embodiment, the packer assembly 74 of the closing system 33 includes a packer wheel biasing element 100 coupled to the packer wheel arm 94 and configured to urge the packer wheel 92 (e.g., the rotational axis of the packer wheel) toward the soil (e.g., soil surface). In the illustrated embodiment, the biasing element 100 includes a torsion spring. However, in other embodiments, the biasing element may include an alternative biasing device and/or additional biasing device(s) (e.g., coil spring(s), pneumatic cylinder(s), hydraulic cylinder(s), resilient member(s), etc.) configured to urge the packer wheel toward the soil. Furthermore, in the illustrated embodiment, the packer assembly 74 includes a packer wheel adjustment assembly 102 configured to control contact force between the packer wheel and the soil (e.g., soil surface). In the illustrated embodiment, the packer wheel adjustment assembly 102 includes a series of notches 104 formed within the packer wheel arm or a structure rigidly coupled to the packer wheel arm. An end of the biasing element 100 (e.g., torsion spring) may be moved between the notches 104 to control the torque applied by the biasing element 100 to the packer wheel arm 94, thereby controlling the contact force between the packer wheel 92 and the soil (e.g., soil surface). While the packer wheel adjustment assembly 102 includes the notches 104 in the illustrated embodiment, in other embodiments, the packer wheel adjustment assembly may include other and/or additional elements to control the contact force between the packer wheel and the soil. For example, if the biasing device(s) include pneumatic cylinder(s) and/or hydraulic cylinder(s), the packer wheel adjustment assembly may include a valve assembly configured to control pressurized fluid flow to the pneumatic/hydraulic cylinder(s).

The row unit 30 includes a spring assembly 106 configured to urge the opener disc into engagement with the soil, to urge the gauge wheel against the soil surface, and to facilitate upward vertical movement of the row unit frame 42 (e.g., in response to contact between the opener disc 50 and an obstruction within the field). In the illustrated embodiment, the spring assembly 106 includes a bolt/tube assembly 108 that connects a lower trunnion 110 to an upper trunnion 112. The bolt/tube assembly 108 and lower trunnion 110 are surrounded by a compression spring 114. In addition, the spring assembly 106 is rotatably coupled to the lower link 38 by a fastener 116 to enable the spring assembly 106 to rotate relative to the lower link 38. In certain embodiments, a downforce actuator is configured to compress the spring assemblies of a group of row units (e.g., on a sub-frame/sub-bar). The force applied by the downforce actuator may be controlled to control the downforce applied by the gauge wheel 54 to the soil surface (e.g., while compressing the spring 114). In addition, the spring 114 is configured to facilitate upward vertical movement of the frame 42 in response to the opener disc 50 or the gauge wheel 54 encountering an obstruction (e.g., rock, branch, etc.) within the field. While the row unit includes the spring assembly in the illustrated embodiment, in other embodiments, the spring assembly may be omitted. For example, in certain embodiments, the spring assembly may be omitted, and a downforce actuator may extend from the toolbar to the row unit (e.g., to the frame of the row unit, to a link of the linkage assembly, etc.).

Because the closing disc arm and the packer wheel arm are independently rotatably coupled to the frame of the row unit, the contact force between the packer wheel and the soil (e.g., the soil surface) may be controlled substantially independently of the contact force between the closing disc(s) and the soil. For example, the contact force between the closing disc(s) and the soil may be adjusted to a first value via the closing disc adjustment assembly, and the contact force between the packer wheel and the soil may be adjusted to a second value via the packer wheel adjustment assembly. Each contact force may be adjusted for particular field conditions (e.g., soil composition, soil moisture, etc.). As a result, the closing system may be utilized to effectively close the trench and/or break up the side wall(s) of the trench for a variety of field conditions (e.g., as compared to utilizing a different closing system for different field conditions).

In the illustrated embodiment, the row unit 30 including the closing system 33 is a seeding/seeder row unit, as compared to a planting/planter row unit. Accordingly, a storage compartment (e.g., hopper, mini-hopper, etc.) for agricultural product is not non-movably coupled to the frame 42 (e.g., as compared to a planting/planter row unit that includes an agricultural product storage compartment, such as a hopper or a mini-hopper configured to receive agricultural product from a central storage compartment, non-movably coupled to the frame). In addition, the seeding/seeder row unit 30 includes a single opener disc 50 (e.g., as compared to a planting/planter row unit that includes a pair of opener discs arranged to form a v-shaped trench). Furthermore, in the illustrated embodiment, a metering device is not non-movably coupled to the frame of the row unit (e.g., as compared to a planting/planter row unit that includes a frame-mounted metering device, such as a vacuum seed meter). However, in other embodiments, a metering device (e.g., seed meter) may be non-movably coupled to the frame of the row unit.

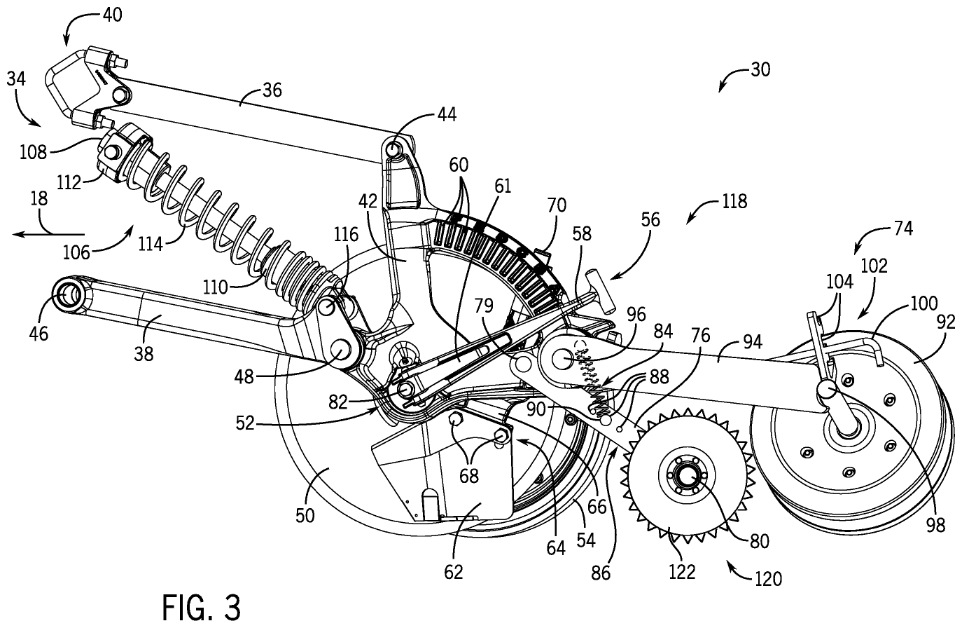

FIG. 3 is a side view of the row unit 30 of FIG. 2 having another embodiment of a closing system 118. In the illustrated embodiment, the closing system 118 includes a closing assembly 120 having a single spiked closing disc 122 rotatably coupled to the closing disc arm 76. The spiked closing disc 122 is configured to close the trench formed by the opener disc and/or to break up the side wall(s) of the trench, thereby enhancing the development of crops from the deposited seeds. As illustrated, the spiked closing disc 122 includes multiple radial spikes (e.g., protrusions) extending outwardly from a central hub. While the closing assembly 120 has a single closing disc 122 in the illustrated embodiment, in other embodiments, the closing assembly may have more closing discs (e.g., 2, 3, 4, or more). In addition, while the closing disc has spikes in the illustrated embodiment, in other embodiments, the closing disc may be substantially smooth. Furthermore, in certain embodiments, the closing assembly may include multiple types of closing discs (e.g., a combination of a smooth closing disc and a spiked closing disc, etc.). In addition, while a spiked closing disc and a smooth closing disc are described above, the closing assembly may include any other suitable type of closing disc(s) (e.g., alone or in combination with other closing disc(s)). For example, in certain embodiments, the closing disc may include shaped protrusions other than spikes to facilitate trench closing for soil having certain properties and/or composition. Indeed, the type and/or number of closing discs may be particularly selected based on soil properties/composition.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A row unit of a seeder comprising:
a frame configured to be coupled to a toolbar of the seeder;
a single opener disc rotatably coupled to the frame;
a closing system, comprising:
a closing disc arm pivotally coupled to the frame;
at least one closing disc rotatably coupled to the closing disc arm, wherein the closing disc arm positions a rotational axis of the at least one closing disc rearward of a rotational axis of the single opener disc relative to a direction of travel of the row unit;
a packer wheel arm pivotally coupled to the frame, wherein the packer wheel arm and the closing disc arm are configured to rotate independently of one another relative to the frame; and
a packer wheel rotatably coupled to the packer wheel arm, wherein the packer wheel arm positions a rotational axis of the packer wheel rearward of the rotational axis of the at least one closing disc relative to the direction of travel of the row unit;
wherein an agricultural product storage compartment is not non-movably coupled to the frame.

2. The row unit of claim 1, wherein the at least one closing disc comprises a single closing disc.

3. The row unit of claim 1, wherein the at least one closing disc comprises a pair of closing discs.

4. The row unit of claim 1, wherein the at least one closing disc comprises a plurality of radial protrusions.

5. The row unit of claim 1, wherein the closing system comprises a closing disc biasing element coupled to the closing disc arm and configured to urge the at least one closing disc toward soil.

6. The row unit of claim 5, wherein the closing system comprises a closing disc adjustment assembly configured to control a contact force between the at least one closing disc and the soil.

7. The row unit of claim 1, wherein the closing system comprises a packer wheel basing element coupled to the packer wheel arm and configured to urge the packer wheel toward soil.

8. The row unit of claim 7, wherein the closing system comprises a packer wheel adjustment assembly configured to control a contact force between the packer wheel and the soil.

9. A row unit of a seeder comprising:
a frame configured to be coupled to a toolbar of the seeder;
a single opener disc rotatably coupled to the frame;
a closing system, comprising:
a closing disc arm pivotally coupled to the frame at a first pivot joint;
at least one closing disc rotatably coupled to the closing disc arm, wherein the closing disc arm positions a rotational axis of the at least one closing disc rearward of a rotational axis of the single opener disc relative to a direction of travel of the row unit;
a packer wheel arm pivotally coupled to the frame at a second pivot joint, wherein the first pivot joint and the second pivot joint are separated from one another on the frame; and
a packer wheel rotatably coupled to the packer wheel arm, wherein the packer wheel arm positions a rotational axis of the packer wheel rearward of the rotational axis of the at least one closing disc relative to the direction of travel of the row unit;
wherein an agricultural product storage compartment is not non-movably coupled to the frame.

10. The row unit of claim 9, wherein a metering device is not non-movably coupled to the frame.

11. The row unit of claim 9, wherein the at least one closing disc comprises a single closing disc.

12. The row unit of claim 9, wherein the at least one closing disc comprises a pair of closing discs.

13. The row unit of claim 9, wherein the at least one closing disc comprises a plurality of radial protrusions.

14. The row unit of claim 9, wherein the closing system comprises a closing disc biasing element coupled to the closing disc arm and configured to urge the at least one closing disc toward soil.

15. The row unit of claim 9, wherein the closing system comprises a packer wheel basing element coupled to the packer wheel arm and configured to urge the packer wheel toward soil.

16. A row unit of a seeder comprising:
a frame configured to be coupled to a toolbar of the seeder;
a single opener disc rotatably coupled to the frame;
a closing system, comprising:
a closing disc arm pivotally coupled to the frame;
at least one closing disc rotatably coupled to the closing disc arm, wherein the closing disc arm positions a rotational axis of the at least one closing disc rearward of a rotational axis of the single opener disc relative to a direction of travel of the row unit;
a closing disc biasing element coupled to the closing disc arm and configured to urge the at least one closing disc toward soil;
a packer wheel arm pivotally coupled to the frame, wherein the packer wheel arm and the closing disc arm are configured to rotate independently of one another relative to the frame;
a packer wheel rotatably coupled to the packer wheel arm, wherein the packer wheel arm positions a rotational axis of the packer wheel rearward of the rotational axis of the at least one closing disc relative to the direction of travel of the row unit; and
a packer wheel basing element coupled to the packer wheel arm and configured to urge the packer wheel toward soil;
wherein an agricultural product storage compartment is not non-movably coupled to the frame.

17. The row unit of claim 16, wherein the closing system comprises a closing disc adjustment assembly configured to control a contact force between the at least one closing disc and the soil.

18. The row unit of claim 16, wherein the closing system comprises a packer wheel adjustment assembly configured to control a contact force between the packer wheel and the soil.

19. The row unit of claim 16, wherein the at least one closing disc comprises a plurality of radial protrusions.

20. The row unit of claim 16, wherein a metering device is not non-movably coupled to the frame.
